(19) United States
(12) Patent Application Publication
(10) Pub. No.: US 2013/0095232 A1
(43) Pub. Date: Apr. 18, 2013

(54) METHOD OF APPLYING VARNISH TO A STATOR

(71) Applicants: Edward L. Kaiser, Orion, MI (US); Micah Joel Fuchs, Detroit, MI (US); David F. Titmuss, Commerce Township, MI (US); Justin Hanson, Dearborn Heights, MI (US)

(72) Inventors: Edward L. Kaiser, Orion, MI (US); Micah Joel Fuchs, Detroit, MI (US); David F. Titmuss, Commerce Township, MI (US); Justin Hanson, Dearborn Heights, MI (US)

(73) Assignee: GM GLOBAL TECHNOLOGY OPERATIONS LLC, Detroit, MI (US)

(21) Appl. No.: 13/275,513

(22) Filed: Oct. 18, 2011

(51) Int. Cl. B05D 5/12

(52) U.S. Cl. 427/104

(57) ABSTRACT

A method of applying varnish to a stator includes orienting a center axis of the stator substantially parallel to gravity, and orienting a crown end of stator windings upward and a weld end of the windings downward, relative to gravity. The crown end and the weld end of the stator are disposed on opposing sides of the core. The weld end is placed above a dip tank and varnish applied to the crown end of the windings with at least one nozzle. The nozzle is controlled along a first direction and a second direction, which are perpendicular to the center axis. The varnish substantially coats the crown end of the windings, runs through the slots, and drips from the weld end of the windings into the dip tank. The dip tank is raised to submerse the weld end of the windings but not the core.

### STATEMENT REGARDING FEDERALLY SPONSORED RESEARCH OR DEVELOPMENT

This invention was made with U.S. Government support under an Agreement/Project number: DE-EE0002629, awarded by the Department of Energy. The U.S. Government may have certain rights in this invention.

### TECHNICAL FIELD

This disclosure relates to the manufacture and assembly of wound stators, and particularly to application of varnish or enamel to the windings of stators.

### BACKGROUND

A stator is the stationary part of an electric machine. The stator interacts with a rotor, which is the moving part of the electric machine. The stator and rotor allow the electric machine to convert mechanical energy to electrical energy (generator) and to convert electrical energy to mechanical energy (motor).

### SUMMARY

A method of applying varnish to a stator is provided. The stator includes a plurality of windings extending through a plurality of slots in a core, and is configured with a center axis. The method includes orienting the center axis of the stator substantially parallel to gravity, orienting a crown end of the windings upward, relative to gravity, and orienting a weld end of the windings downward, relative to gravity. The crown end and the weld end of the stator are disposed on opposing sides of the core.

The method also includes orienting the weld end above a dip tank and applying a varnish to the crown end of the windings with at least one nozzle located above the stator. The method includes controlling the nozzle (or nozzles) along a first direction and a second direction, each of which are perpendicular to the center axis. Therefore, the varnish substantially coats the crown end of the windings, runs through the slots, and drips from the weld end of the windings into the dip tank.

The method further includes raising the dip tank relative to the weld end of the windings, and then lowering the dip tank relative to the weld end of the windings. Therefore, the weld end of the windings are submersed in varnish within the dip tank, but the core is not in contact with varnish in the dip tank.

The above features and advantages, and other features and advantages, of the present invention are readily apparent from the following detailed description of some of the best modes and other embodiments for carrying out the invention, as defined in the appended claims, when taken in connection with the accompanying drawings.

### BRIEF DESCRIPTION OF THE DRAWINGS

FIG. 1 is a schematic, isometric view of a stator and components for applying a varnish to windings of the stator;

FIG. 2 is a schematic, side view of the stator and components shown in FIG. 1; and

FIG. 3 is a schematic flow chart diagram of an algorithm or method for applying varnish to a stator, such as the stator shown in FIGS. 1 and 2.

### DETAILED DESCRIPTION

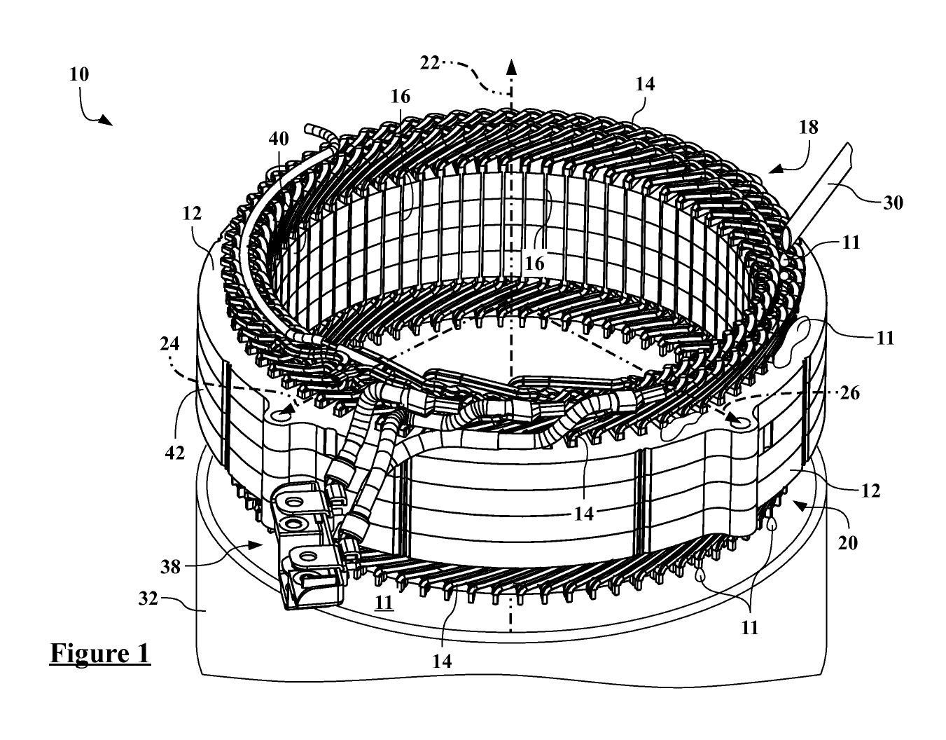

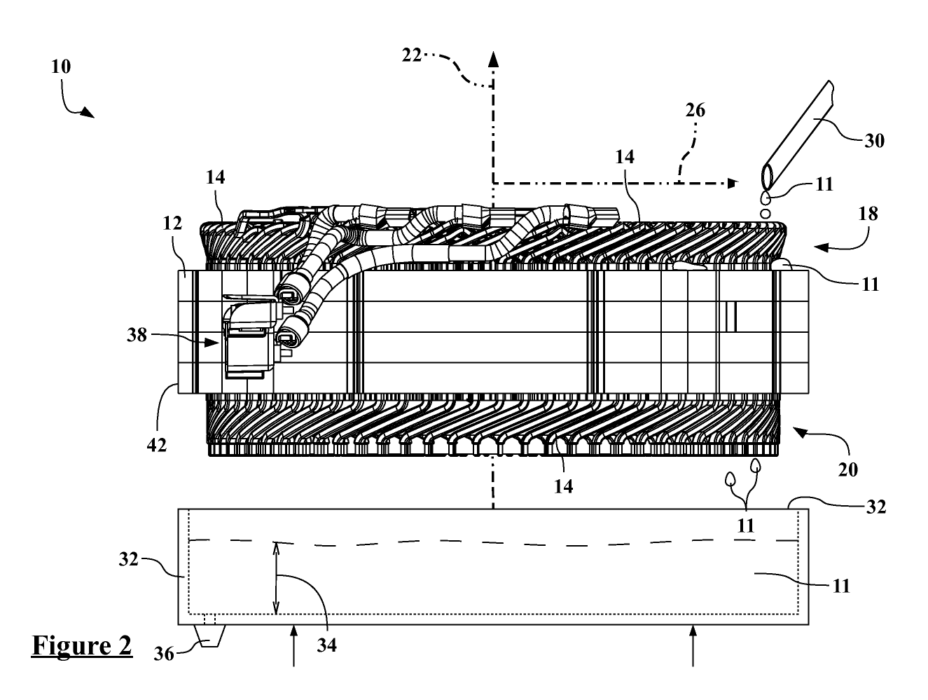

Referring to the drawings, wherein like reference numbers correspond to like or similar components whenever possible throughout the several figures, there is shown in FIG. 1 and FIG. 2 two schematic views of a stator 10, which may be used in an electric machine (not shown). The stator 10 shown in FIGS. 1 and 2 is an external, bar-wound stator, which cooperates with an internal rotor (not shown) in the electric machine.

FIG. 1 shows an isometric view of the stator 10 and other components for applying an enamel or varnish 11 to specific portions of the stator 10. FIG. 2 shows a side view of the stator 10. Features and components shown in other figures may be incorporated and used with those shown in FIG. 1, and components may be mixed and matched between the different configurations shown.

While the present invention is described in detail with respect to automotive applications, those skilled in the art will recognize the broader applicability of the invention. Those having ordinary skill in the art will recognize that terms such as “above,” “below,” “upward,” “downward,” et cetera, are used descriptively of the figures, and do not represent limitations on the scope of the invention, as defined by the appended claims.

As shown in FIGS. 1 and 2, the stator 10 is generally formed of two main components, a plurality of windings 14 and a core 12. The windings 14 are formed from conductors, such as the bar-shaped wires shown, and extend through a plurality of slots 16 in the core 12. As shown in FIGS. 1 and 2, the core 12 may be formed from multiple laminations (not separately numbered) or stacks. The core 12 may alternatively be formed as a solid core or as a segmented core.

The stator 10 defines a crown end 18 of the windings 14, which is shown oriented upward, relative to gravity (and also as viewed in FIGS. 1 and 2). The stator 10 also defines a weld end 20 of the windings 14, which is shown oriented downward, relative to gravity (and also as viewed in FIGS. 1 and 2). The crown end 18 and the weld end 20 are disposed on opposing sides of the core 12.

The stator 10 has a center axis 22, which is shown oriented substantially parallel to gravity (pulling downward, as viewed in FIGS. 1 and 2). The rotor would share substantially the same center axis 22, and would rotate about the center axis 22 during operation of the electric machine. Although not shown, the stator 10 may be attached to a jig or mounting bracket to assist in holding, moving, and aligned the stator 10 during this manufacturing process and other processes.

For cylindrical coordinates, in addition to the center axis 22, the stator 10 also defines a radial axis, which extends perpendicularly outward from the center axis, and an angular axis or a tangential axis, which is in the direction of rotation about the radial axis. The stator 10 may also use Cartesian coordinates, with the center axis 22 being the z-axis, and also defining an x-axis 24 and a y-axis 26, both of which are perpendicular to the center axis 22. The radial and angular axes, or the x-axis 24 and the y-axis 26, may be referred to as a first direction and second direction relative to the center axis 22. Designation as first or second, or the specific coordinate system, is not limiting.

Instead of manufacturing the stator 10 with pre-enameled windings 14, the stator 10 is configured to receive the varnish 11 after the windings 14 are installed or assembled to the core 12 through slots 16. Some portions of the windings 14, such as contact points or weld points, may not need to be enameled, and any pre-enameled surfaces in those portions would have to be cleaned or otherwise have the enamel removed. The varnish 11 is applied to the crown end 18 of the windings 14 with at least one nozzle 30. While only one of the nozzles 30 is shown in FIGS. 1 and 2, multiple nozzles 30 may be used to more-quickly apply the varnish 11.

The nozzles 30 are located above the stator 10, and controllably drip, flow, or spray the varnish 11 onto the crown end 18. The nozzles 30 may be mounted, or incorporated, in a moveable fixture (not shown), such as a robotic arm or programmable track system. Therefore, the location of the nozzles 30 is controlled in at least a first direction and a second direction, and the nozzles 30 may be moved along one or more paths above the windings 14.

The first direction may be the x-axis 24 and the second direction may be the y-axis 26. The height of the nozzles 30 along the center axis 22 may also be controlled during application of the varnish 11, or may be set at a fixed level by the application structure or tooling. Therefore, the stator 10 may remain substantially fixed while the nozzles 30 are moved along the x-axis 24 and the y-axis 26 to collectively apply varnish 11 to the whole crown end 18 of the windings 14.

The stator 10 is oriented with the weld end 20 above a dip tank 32. The varnish 11 is applied at a controlled rate, such that the varnish 11 substantially coats the crown end 18 of the windings 14, runs through the slots 16, and drips from the weld end 20 of the windings 14 into the dip tank 32. The runoff of varnish 11 is therefore collected and saved by the dip tank 32. The varnish 11 may flow through the slots 16 due to wicking action.

The dip tank 32 may then be raised, relative to the weld end 20, such that the weld end 20 of the windings 14 are submersed in varnish 11 in the dip tank 32. However, the dip tank 32 is not raised so far as to allow the core 12 to come into contact with varnish 11 in the dip tank 32. After the weld end 20 of the windings 14 are coated, the dip tank 32 may be lowered back below the weld end 20 of the windings 14.

Applying the varnish 11 may include a controller or control system (not shown) configured to actuate the fixtures controlling the location of the nozzles 30. The control system may include one or more components with a storage medium and a suitable amount of programmable memory, which are capable of storing and executing one or more algorithms or methods to effect control of the nozzles 30, the dip tank 32 and, possibly, other components. The control system may be in communication with numerous other sensors and communication systems of the vehicle. Each component of the control system may include distributed controller architecture. Additional modules or processors may be present within the control system.

A fluid level 34 of varnish 11 in the dip tank 32 may be controlled to ensure coating of the weld end 20 and to prevent coating of the core 12 during the dip. The fluid level 34 may be maintained or controlled with a valve 36 in the dip tank 32, and additional sensors, valves, or supply passages may also be included (not shown). The fluid temperature of the varnish 11 in the dip tank 32 may also be controlled.

Throughout application of the varnish 11 to the crown end 18, raising the dip tank 32, and lowering of the dip tank 32, the orientation of the center axis 22 is maintained substantially constant. To facilitate the process and to maintain the orientation of the center axis 22, the stator 10 may be attached to a fixture that allows the controller to know, estimate, or determine the location of the stator 10 relative to the nozzles 30 and the dip tank 32.

Depending upon the type of enamel or varnish 11 applied to the windings 14, the stator 10 may need additional processes to prevent movement of the varnish 11 from the targeted areas of the stator 10. Some varnish 11 may require curing processes. The stator 10 may be subjected to a partial curing process after lowering the dip tank 32. The partial curing process may be configured to fix the location of the varnish 11, such that it does not run or drip, but may not be sufficient to permanently complete the enameling process. After the partial curing process, the stator 10 may be moved without altering the distribution of the varnish 11.

The stator 10 may subsequently be subjected to a full, or permanent, curing process after the partial curing process. For example, and without limitation, the varnish 11 may be subjected to a partial curing process that includes applying an ultraviolet cure to the varnish 11, and then the stator 10 may be moved to another location or another facility. Then the full curing process may include applying a heat cure to the stator 10, such as with an oven. In some manufacturing and assembly processes, multiple stators 10 may be grouped in an oven for the full curing process.

Application and adherence of the varnish 11 may be improved if the stator 10 is hot when the varnish 11 is applied to the windings 14. Therefore, the stator 10 may be preheated prior to applying the varnish 11 to the crown end 18 of the windings 14.

For some configurations of the stator 10, it may be beneficial to test the stator 10 while it is hot. Therefore, while the fixture is attached to the stator 10 and maintaining orientation of the center axis 22, the stator 10 may be tested following preheating the stator 10. Since the stator 10 was already preheated for the varnish 10, testing may not require additional heating. Testing may occur by connecting testing equipment to an interface 38.

The core 12 has an inner surface 40 and an outer surface 42. The rotor rotates near the inner surface 40. The outer surface 42 may be adjacent other structure, such as a stator can, transmission housing, or other support structure of the electric machine (not shown). During application of the varnish 11 to the windings 14, the varnish 11 is not placed into contact with either the inner surface 40 or the outer surface 42.

Application of the varnish 11 from the nozzles 30 and with the dip tank 32 is characterized by the absence of a masking agent applied the stator 10, which would be subsequently removed. Nor does the stator 10 require hot wiping varnish 11 from the inner surface 40 and the outer surface 42 before the varnish 11 is cured or using any abrasive cleanup on the inner surface 40 and the outer surface 42. Therefore, varnish 11 does not need to be removed after applying or curing the varnish 11.

As shown in FIGS. 1 and 2, some varnish 11 may collect or pool on the top surface of the core 12 adjacent to the crown end 18 of the windings 14 and the top of the slots 16. The flow rate of the varnish 11 and the movement of the nozzles 30 is controlled to permit some pooling of varnish 11 but not to allow the varnish 11 to drip or run over the sides onto the inner surface 40 and the outer surface 42.

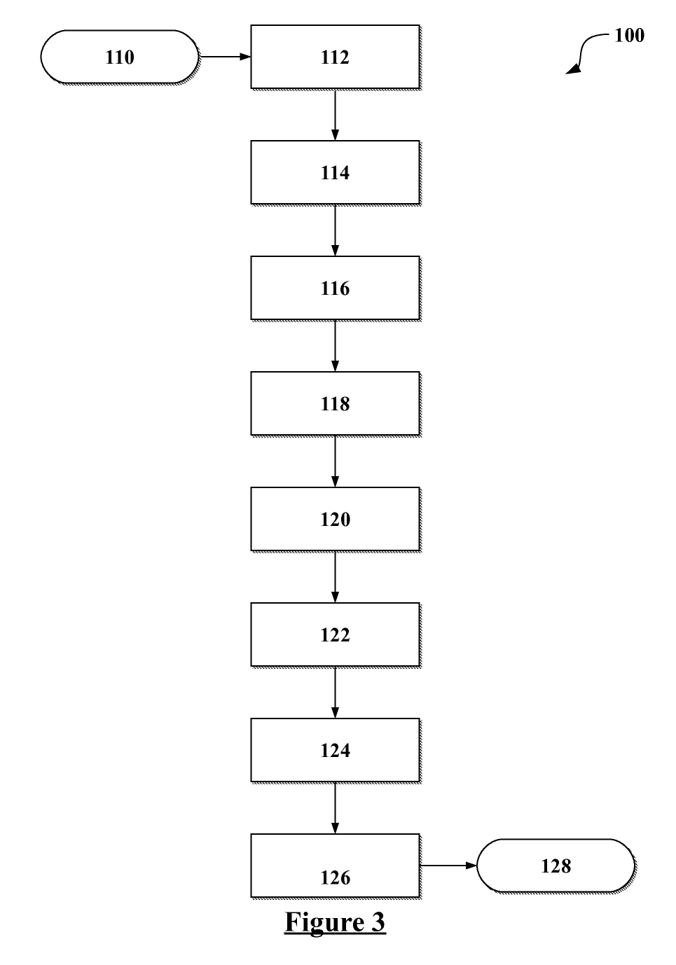

Referring now to FIG. 3, and with continued reference to FIGS. 1 and 2, there is shown a schematic flow chart diagram of an algorithm or method 100 for manufacturing rotors and stators, such as the stator 10 shown in FIGS. 1 and 2. The exact order of the steps of the method 100 shown in FIG. 3 is not limiting. Steps may be reordered, steps may be omitted, and additional steps may be included. Furthermore, the method 100 may be a portion or sub-routine of another algorithm or method. FIG. 3 shows only a high-level diagram of the method 100.

For illustrative purposes, the method 100 may be described with reference to the elements and components shown and described in relation to FIGS. 1 and 2. However, other components may be used to practice the method 100 and other components may be used to practice the invention defined in the appended claims.

Step 110: Start/Initialize.

The method 100 begins with a start or initialization step, which may include set up of the stator 10, the components for applying the varnish 11, or mounting of the stator 10 to a support fixture, jig, or tooling fixture. The method 100 may operate for each stator 10, may be operating constantly as numerous, consecutive stators 10 are produced, or may be operated as a single cycle on a batch of stators 10.

Step 112: Align and Mount Stator.

The stator 10 is aligned and mounted as part of the method 100. Aligning may include orienting the center axis 22 substantially parallel to gravity, orienting the crown end 18 of the windings 14 upward, and orienting the weld end 20 downward above the dip tank 32. The orientation of the center axis 22 will be maintained substantially constant throughout the method 100. Aligning may include orienting and moving the support fixture to other equipment.

Step 114: Preheat Stator.

The method 100 includes preheating the stator 10 prior to applying the varnish 11. Preheating may be beneficial to application of the varnish 11 to the windings 14, and may assist in causing the varnish 11 to flow or wick through the slots 16.

Step 116: Hot-Test Stator.

Optionally, the method 100 may include testing the stator 10 after preheating the stator 10. In order to test the stator 10, diagnostic equipment may be connected to the interface 38.

Step 118: Vertical Trickle Varnish.

To begin the enameling process, the method 100 includes applying the varnish 11 to the crown end 18 of the windings 14 with at least one nozzle 30. The nozzles 30 are located above the stator 10, such that controlled flow of the varnish 11 falls onto the crown end 18 from the nozzles 30.

Step 120: Control Nozzles in X and Y.

As the nozzles are applying the varnish 11, the method 100 includes controlling the nozzles 30 in, at least, a first direction and a second direction relative to the stator 10. The nozzles 30 may be moved or controlled by a fixture, an armature, or another component capable of holding and controlling the location of one or more nozzles 30 to distribute the varnish 11 over the windings 14. Alternatively, the nozzles 30 may be incorporated into moveable components for control in the first and second directions.

The first direction may be along a radial axis or the x-axis 24. The second direction may be along a tangential direction or the y-axis 26. The x-axis 24 and the y-axis 26 are perpendicular to the center axis 22. Therefore, the varnish 11 substantially coats the crown end 18 of the windings 14, runs through the slots 16, and drips from the weld end 20 of the windings 14 into the dip tank 32.

Step 122: Weld-End Dip.

The method 100 includes raising the dip tank 32 relative to the weld end 20 of the windings 14. Therefore the weld end 20 of the windings 14 are submersed in the varnish 11 in the dip tank 32. However, the dip tank 32 is not raised too far, such that the core 12 is not in contact with varnish 11 in the dip tank 32. After coating the weld end 20—which may include continuous motion or may have a pause while the weld end 20 is submersed in the varnish 11—the method 100 includes lowering the dip tank 32 relative to the weld end 20 of the windings 14.

The method 100 may also include controlling the fluid level 34 in the dip tank 32, such as by selectively opening the valve 36. Additionally, the method 100 may include controlling the fluid temperature in the dip tank 32.

Step 124: Partial Cure.

After lowering the dip tank 32 relative to the weld end 20 of the windings 14, the method 100 may include subjecting the stator 10 to a partial curing process. The partial curing process may include applying an ultraviolet cure to the varnish 11, such as by shining ultraviolet light on the stator 10.

The orientation of the center axis 22 will be maintained substantially constant throughout at least application of the partial cure. After the partial cure, the stator 10 may be movable without altering the location and coating consistency of the varnish 11 on the windings 14.

Step 126: Complete Cure.

The method 100 may include subjecting the stator 10 to a full, permanent, or complete curing process. If the partial curing process was applied, the full curing process will occur after the partial curing process. The full curing process may include applying a heat cure to the stator 10. Alternatively, the full curing process may be based solely upon time, such that the varnish 11 may have been activated or triggered to begin curing and that process may need only time.

Step 128: End/Repeat.

The method 100 may then end or move to the next press cycle. Ending may include sending a signal that the stator 10 is complete and may be removed from the fixture, such that another stator 10 or another batch of stators 10 may have varnish 11 applied thereto.

Note that for the method 100 the end processes do not include removing a masking agent applied the stator 10. The stator 10 also does not require hot wiping varnish 11 from the inner surface 40 and the outer surface 42 before the varnish 11 is cured, or using any abrasive cleanup on the inner surface 40 and the outer surface 42.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. A method of applying varnish to a stator, wherein the stator has a plurality of windings extending through a plurality of slots in a core, the method comprising:
orienting a center axis of the stator substantially parallel to gravity, wherein the stator is configured to rotate about the center axis;
orienting a crown end of the windings upward, relative to gravity;
orienting a weld end of the windings downward, relative to gravity, wherein the crown end and the weld end are disposed on opposing sides of the core;
orienting the weld end above a dip tank;
applying a varnish to the crown end of the windings with at least one nozzle located above the stator;
controlling the at least one nozzle along a first direction and a second direction, wherein the first and second directions are perpendicular to the center axis, such that the varnish substantially coats the crown end of the windings, runs through the slots, and drips from the weld end of the windings into the dip tank;
raising the dip tank relative to the weld end of the windings, such that the weld end is submersed in varnish in the dip tank but the core is not in contact with varnish in the dip tank; and
lowering the dip tank relative to the weld end of the windings.

2. The method of claim 1, further comprising:
subjecting the stator to a partial curing process after lowering the dip tank; and
subjecting the stator to a full curing process after the partial curing process.

3. The method of claim 2,
wherein the partial curing process includes applying an ultraviolet cure to the varnish, and
wherein the full curing process includes applying a heat cure to the stator.

4. The method of claim 3, further comprising:
controlling a fluid level of the varnish in the dip tank; and
controlling a fluid temperature of the varnish in the dip tank.

5. The method of claim 4, wherein the orientation of the center axis is maintained substantially constant throughout the method.

6. The method of claim 5, further comprising:
preheating the stator prior to applying the varnish to the crown end of the windings; and
testing the stator after preheating the stator.

7. The method of claim 6, wherein the method is characterized by the absence of a masking agent applied the stator.

8. The method of claim 7, wherein the core has an inner surface and an outer surface, and wherein the varnish is not placed into contact with the inner surface and the outer surface.

9. A method of applying varnish to a stator, wherein the stator has a plurality of windings extending through a plurality of slots in a core, the method comprising:
orienting a center axis of the stator substantially parallel to gravity, wherein a rotor is configured to rotate about the center axis of the stator;
orienting a crown end of the windings upward, relative to gravity;
orienting a weld end of the windings downward, relative to gravity, wherein the crown end and the weld end are disposed on opposing sides of the core;
orienting the weld end above a dip tank;
applying a varnish to the crown end of the windings with at least one nozzle located above the stator;
controlling the at least one nozzle along a first direction and a second direction, wherein the first and second directions are perpendicular to the center axis, such that the varnish substantially coats the crown end of the windings, runs through the slots, and drips from the weld end of the windings into the dip tank;
raising the dip tank relative to the weld end of the windings, such that the weld end of the windings are submersed in varnish in the dip tank but the core is not in contact with varnish in the dip tank;
lowering the dip tank relative to the weld end of the windings;
subjecting the stator to a partial curing process after lowering the dip tank; and
maintaining orientation of the core such that the center axis has a substantially-constant position throughout the method, and wherein the varnish is not placed into contact with an inner surface and an outer surface of the core.

10. The method of claim 9, further comprising:
preheating the stator prior to applying the varnish to the crown end of the windings;
testing the stator after preheating the stator;
controlling a fluid level in the dip tank; and
controlling a fluid temperature in the dip tank, wherein the method is characterized by the absence of a masking agent applied to the stator.

11. A method of applying varnish to a stator, wherein the stator has a plurality of windings extending through a plurality of slots in a core, the method comprising:
orienting a center axis of the stator substantially parallel to gravity, wherein the stator is configured to rotate about the center axis;
orienting a crown end of the windings upward, relative to gravity;
orienting a weld end of the windings downward, relative to gravity, wherein the crown end and the weld end are disposed on opposing sides of the core;
orienting the weld end above a dip tank;
applying a varnish to the crown end of the windings with at least one nozzle located above the stator;
controlling the at least one nozzle along a first direction and a second direction, wherein the first and second directions are perpendicular to the center axis, such that the varnish substantially coats the crown end of the windings, runs through the slots, and drips from the weld end of the windings into the dip tank;
controlling a fluid level of the varnish in the dip tank;
controlling a fluid temperature of the varnish in the dip tank;
raising the dip tank relative to the weld end of the windings, such that the weld end is submersed in varnish in the dip tank but the core is not in contact with varnish in the dip tank; and
lowering the dip tank relative to the weld end of the windings.

12. The method of claim 11, further comprising:
preheating the stator prior to applying the varnish to the crown end of the windings.

13. The method of claim 12, wherein the orientation of the center axis is maintained substantially constant throughout the method.
